(19) United States
(12) Patent Application Publication
(10) Pub. No.: US 2012/0147700 A1
(43) Pub. Date: Jun. 14, 2012

(54) Determining Streamer Depth and Sea Surface Profile

(76) Inventors: Svein Arne Frivik, Oslo (NO); Nicolas Goujon, Oslo (NO); Halvor S. Groenaas, Oslo (NO)

(21) Appl. No.: 12/967,904

(22) Filed: Dec. 14, 2010

(51) Int. Cl. G01V 1/38

(52) U.S. Cl. 367/19; 367/21

(57) ABSTRACT

A technique includes receiving data indicative of acoustic measurements acquired by receivers disposed on a seismic receiver spread including at least one streamer. The technique includes processing the data in a machine to determine a depth and/or shaped of the spread.

### BACKGROUND

The invention generally relates to determining streamer depth and sea surface profile.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones and/or accelerometers), and industrial surveys may deploy only one type of sensor or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes receiving data indicative of acoustic measurements acquired by receivers disposed on a seismic receiver spread including at least one streamer. The technique includes processing the data in a machine to determine a depth of the spread.

In another embodiment of the invention, a technique includes receiving data indicative of acoustic measurements acquired by receivers disposed on a seismic spread including at least one streamer. The technique includes processing the data in a machine to determine a sea surface shape.

Advantages and other features of the invention will become apparent from the following drawing, description and claims.

### BRIEF DESCRIPTION OF THE DRAWING

FIGS. 1 and 2 are schematic diagrams of marine-based seismic acquisition systems according to embodiments of the invention.

FIG. 3 is an illustration of the geometry used to determine streamer depth and sea surface shape according to embodiments of the invention.

FIG. 4 is a flow diagram depicting a technique to determine the depth of a streamer spread according to an embodiment of the invention.

FIGS. 5 and 6 are flow diagrams depicting techniques to determine sea surface shape according to an embodiment of the invention.

FIG. 7 is a schematic diagram of a system to determine a sea surface spectrum according to an embodiment of the invention.

FIG. 8 is a schematic diagram of a data processing system according to an embodiment of the invention.

### DETAILED DESCRIPTION

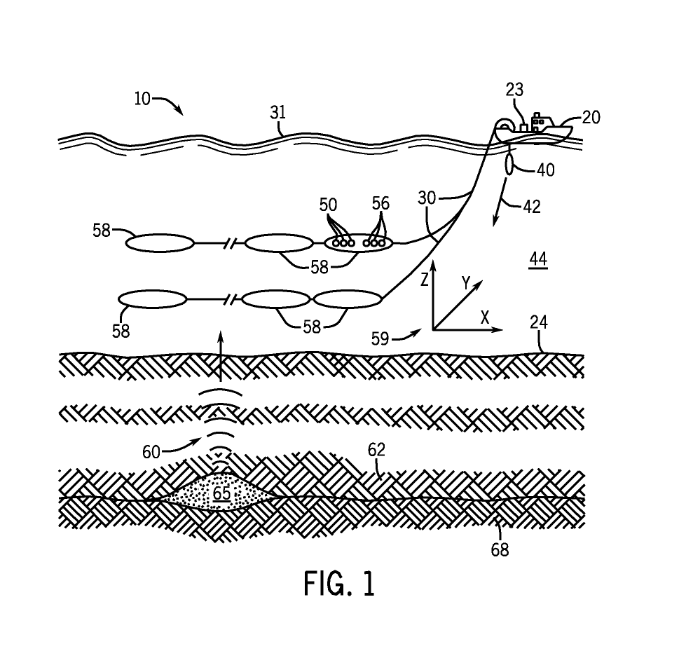

In accordance with embodiments of the invention disclosed herein, a marine-based seismic data acquisition system 10 includes a survey vessel 20, which tows one or more seismic streamers 30 (one exemplary streamer 30 being depicted in FIG. 1) behind the vessel 20. In one non-limiting example, the streamers 30 may be arranged in a spread in which multiple streamers 30 are towed in approximately the same plane at the same depth. As another non-limiting example, the streamers 30 may be towed at multiple depths, such as in an over/under spread, as depicted in FIG. 1.

Each seismic streamer 30 may be several thousand meters long and may contain various support cables (not shown), as well as wiring and/or circuitry (not shown) that may be used to support communication along the streamers 30. In general, the streamer 30 includes a primary cable into which is mounted seismic sensors that record seismic signals.

In accordance with embodiments of the invention, the streamer 30 is a multi-component streamer, which means that the streamer 30 contains particle motion sensors 56 and pressure sensors 50. The pressure 50 and particle motion 56 sensors may be part of a multi-component sensor unit 58. Each pressure sensor 50 is capable of detecting a pressure wavefield, and each particle motion sensor 56 is capable of detecting at least one component of a particle motion that is associated with acoustic signals that are proximate to the sensor 56. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the streamer 30 may include hydrophones, geophones, particle displacement sensors, particle velocity sensors, accelerometers, pressure gradient sensors, or combinations thereof.

As a non-limiting example, in accordance with some embodiments of the invention, the particle motion sensor 56 measures at least one component of particle motion along a particular sensitive axis 59 (the x, y or z axis, for example). As a more specific example, the particle motion sensor 56 may measure particle velocity along the depth, or z, axis; particle velocity along the crossline, or y, axis; and/or velocity along the inline, or x, axis. Alternatively, in other embodiments of the invention, the particle motion sensor(s) 56 may sense a particle motion other than velocity (an acceleration, for example).

In addition to the streamer(s) 30 and the survey vessel 20, the marine seismic data acquisition system 10 also includes one or more seismic sources 40 (one exemplary seismic source 40 being depicted in FIG. 1), such as air guns and the like. In some embodiments of the invention, the seismic source(s) 40 may be coupled to, or towed by, the survey vessel 20. Alternatively, in other embodiments of the invention, the seismic source(s) 40 may operate independently of the survey vessel 20, in that the source(s) 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic source(s) 40 and expand radially with a vertical component through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are created by the seismic source(s) 40 produce corresponding reflected acoustic signals, or pressure waves 60, which are sensed by the towed seismic sensors. It is noted that the pressure waves that are received and sensed by the seismic sensors include “up going” pressure waves that propagate to the sensors without reflection, as well as “down going” pressure waves that are produced by reflections of the pressure waves 60 from an air-water boundary, or free surface 31.

The seismic sensors generate signals (digital signals, for example), called “traces,” which indicate the acquired measurements of the pressure and particle motion wavefields. The traces are recorded and may be at least partially processed by a signal processing unit 23 that is deployed on the survey vessel 20, in accordance with some embodiments of the invention. For example, a particular pressure sensor 50 may provide a trace, which corresponds to a measure of a pressure wavefield by its hydrophone; and a given particle motion sensor 56 may provide (depending on the particular embodiment of the invention) one or more traces that correspond to one or more components of particle motion.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a data processing system that may be, for example, located on land, on a streamer 30, distributed on several streamers 30, on a vessel other than the vessel 20, etc.

Referring to FIG. 2, as illustrated in a top view, the vessel 20 may tow a spread of different streamers 30 at different depths. In this regard, some of the streamers 30 may be towed, in general, in a particular plane, while other streamers 30 may be towed at a different depth in an over/under arrangement. As depicted in FIG. 2, each streamer 30 may span a length of over ten kilometers (km). In general, each streamer 30 may have head end 32 and tail end 34 buoys and may also include various birds, or steering devices, for purposes of guiding the streamer 30. Due to sea conditions and the length of the spread, the depth of the streamers 30 may vary with respect to each other and along their respective lengths.

It may be important to accurately determine the streamer depth. For example, deghosting of the seismic data may rely on an accurate assessment of the streamer depth. Traditionally, the streamer depth is measured using depth sensors, which acquire data indicative of the static pressure. However, in the case of rough weather (i.e., significant surface waves), the static pressure may be a relatively poor indicator of the actual depth of the seismic sensors. In other words, the depth varies with the wave height.

The time shift between the upgoing wavefield and its ghost (the reflection from the sea surface) varies with the distance between the streamer and the sea surface. Therefore, the amplitude and time shift of the ghost varies with the curvature of the sea surface above the streamer (i.e., varies with the sea shape). It is therefore important to accurately determine both the distance from the streamer 30 to the sea surface 31 (see FIG. 1) and the three-dimensional (3-D) shape of the sea surface above the streamer 30 to be able to correctly account for perturbations, which are caused by the rough seas. It is also important to determine the 3-D sea surface shape between streamers 30, especially for multi-component streamers making a vector measurement of the wavefield, as the oblique arrival may be reflected from the sea surface a significant distance away from the streamer 30.

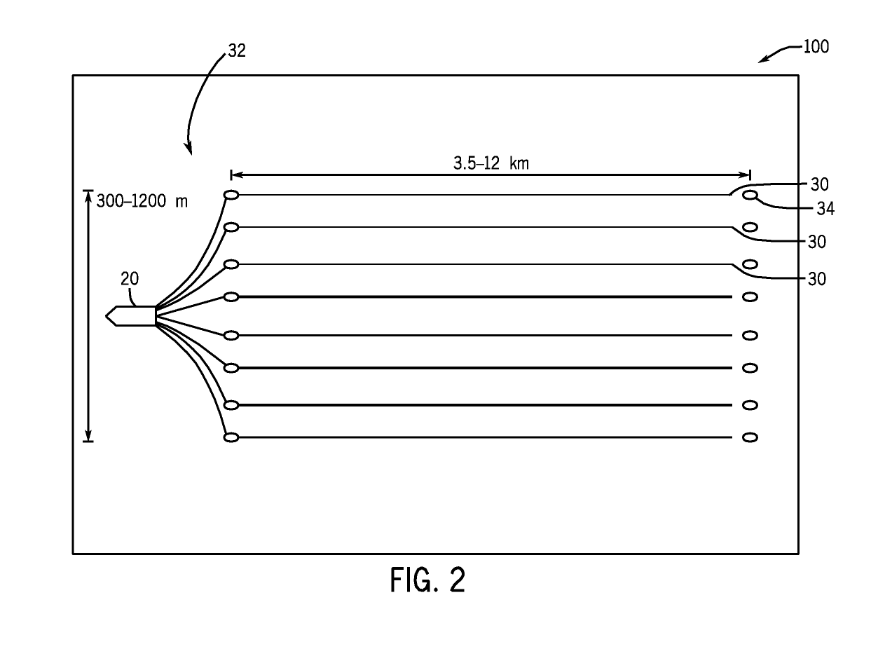

Referring FIG. 3, in accordance with embodiments of the invention described herein, each streamer 30 includes acoustic sources, called “pingers” 154, which are disposed at regular intervals along the streamer 30 and along the seismic spread. The pingers 154 emit acoustic signals, which are recorded by the seismic sensor units 58 (recorded by the hydrophones of the units 58, for example). In accordance with some embodiments of the invention, the pingers 154 may also be used for navigation and/or positioning purposes. In this regard, the pingers 154 may be part of an intrinsic range modulated acoustics array (IRMA), in accordance with some embodiments of the invention. However, in accordance with other embodiments of the invention, acoustic sources other than pingers 154 or pingers that are part of an IRMA array may be used. In the context of this application, the acoustic sources, such as the pingers 154, emit energy in a frequency range that is above the frequency range (0 to 250 Hz, for example) of the energy emitted by seismic sources, and the measurement of this acoustic energy is referred to as an “acoustic measurement” herein. In accordance with some embodiments of the invention, the pingers 154 emit acoustic energy in a frequency range between approximately 250 Hz to 4 kHz.

As illustrated in FIG. 3, each pinger 154, when activated, produces acoustic waves, which each produces multiple waves that propagate along different paths to the seismic sources. In this regard, each acoustic wave produced by the pinger 154 reflects off of the sea surface to produce a sea surface wave that is incident on the seismic sensor, reflects off of the sea bottom to produce a sea bottom reflected wave that is incident on the seismic sensor and travels as a direct wave to the seismic sensor. For the specific example depicted in FIG. 3, a particular seismic sensor unit 58a receives energy along three different paths due to a source event emitted by the pinger 154. In this regard, the seismic sensor 58a receives a direct arrival along a path segment 164, which has an associated travel time called, “T_{D}.” The seismic sensor unit 58a receives a reflected surface wave, which travels from the pinger 154 to the sea surface 31 along segment path 160 and reflects off of the sea surface along path segment 162 to the seismic sensor unit 58a. The reflected surface wave has an associated travel time called, “T_{SUR}.” The acoustic wave also travels along a path segment 170 to the sea floor 24, where the wave is reflected along a path segment 174 to the seismic sensor unit 58a. The sea floor reflection has an associated travel time called, “T_{SFR}.”

Given the above-described travel times, the streamer depth (called “Z_{S}”) at a particular position along the streamer 30 may be determined as follows:

Z_{S}=½\sqrt{(cT_{SUR,i})²−Xᵢ²}, Eq. 1

where “c” represents the speed of sound in the water column; and “X” represents the offset from the source to the receiver. The index i represent the Eq. 1 may be calculated for several offsets for purposes of averaging the streamer depth measurements or as a part of measuring the shape of the surface.

Alternatively, the Z_{S} streamer depth may be determined as follows:

$${Z}_{S} = \frac{c}{z} \sqrt{{T}_{SUR , i}^{2} - {T}_{D , i}^{2}} . \qquad Eq . 2$$

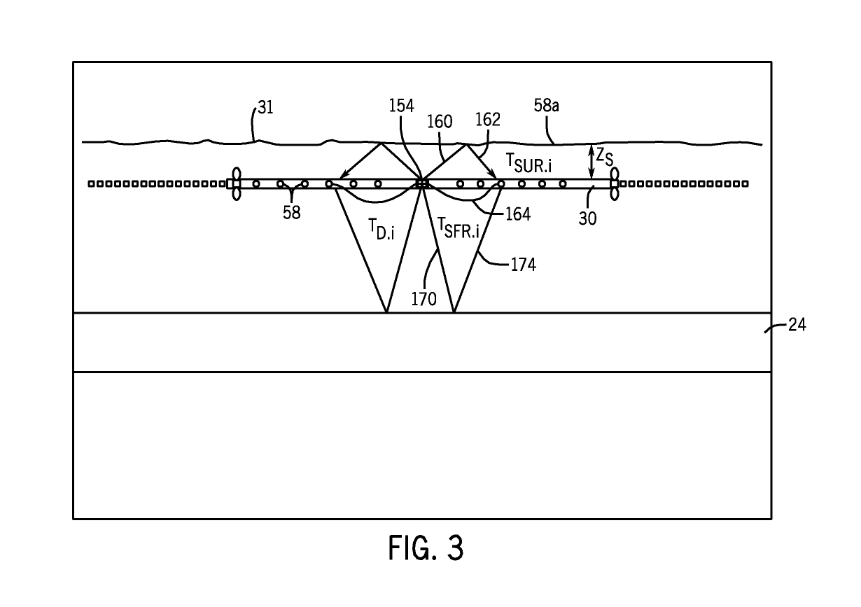

Thus, referring to FIG. 4, in accordance with embodiments of the invention, a technique 200 includes receiving data (block 204) indicative of acoustic measurements acquired by receivers disposed on a seismic receiver spread and processing (block 208) the data to determine a depth of the spread.

Equations 1 and 2 assume a flat sea surface. However, in accordance with other embodiments of the invention, an unknown varying sea surface may be assumed; and for this arrangement, equations similar to Eqs. 1 and 2 may be simultaneously solved for purposes of determining both the sea surface heights at a given point as well as the depth.

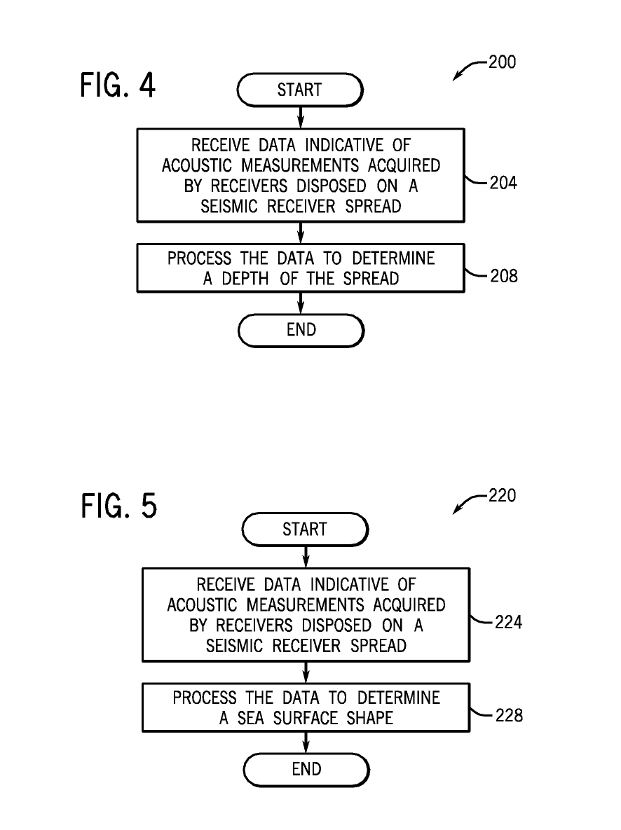

Thus, referring to FIG. 5, in accordance with some embodiments of the invention, a technique 220 includes receiving data (block 224) indicative of acoustic measurements acquired by receivers disposed on a seismic receiver spread and processing (block 228) the data to determine a sea surface shape.

Using inline ranges based on direct arrival, the speed of sound c may be determined in such way that the streamer depth may be sought for locally. Alternatively, the speed of sound c may be measured using corrected total depth (CTD) probes, termistor-chains, or a similar device.

In accordance with some embodiments of the invention, the above-described travel times may be combined with other parameters for purposes of determining a complete wave spectrum for the surface wave. For example, in accordance with some embodiments of the invention, acoustic measurements of depth acquired using depth sensors may be combined with back scattering data provided by a wave radar, which is used for front end positioning, as described in U.S. patent application Ser. No. 12/706,791, which was filed on Feb. 17, 2010 (attorney docket no. 14.0495), which is hereby incorporated by reference in its entirety. Furthermore, these measurements may be combined with inclination measurements. Thus, referring to FIG. 6, in accordance with some embodiments of the invention, a technique 250 includes determining (block 254) travel times of direct arrivals, sea surface reflected waves and sea bed reflected waves, as described above. These travel times are used pursuant to block 258 as additional measurements, that are combined with depth sensor measurements, radar back scattering measurements and streamer inclination measurements to determine the sea surface shape.

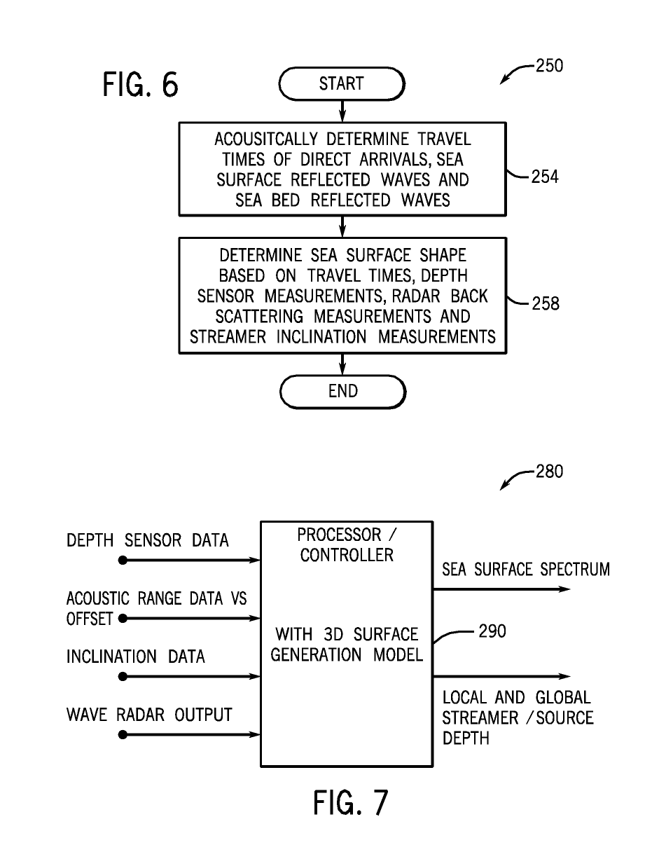

As depicted in FIG. 7, in accordance with some embodiments of the invention, a three-dimensional sea surface generation model 290 may take into account such information as depth sensor data, acoustic range data versus offset, inclination data and wave radar output to provide such information as the sea surface spectrum and local and global streamer/source depth. In accordance with some embodiments of the invention, the model 290 may be a Kalman filter.

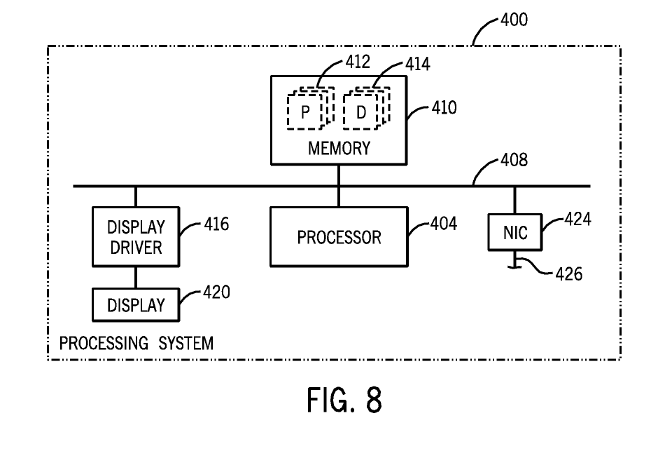

Referring to FIG. 8, in accordance with some embodiments of the invention, a data processing system 400 may be used for purposes of processing data indicative of acoustic measurements acquired by receivers disposed on a seismic receiver spread for purposes of determining a depth of the spread and/or a surface sea shape. The data processing system 400 may be part of the signal processing unit 23 (see FIG. 1) in some implementations. It is noted that the architecture of the processing system 400 is illustrated merely as an example, as the skilled artisan would recognize many variations and deviations therefrom. For example, in some embodiments of the invention, the processing system may be a distributed system that is located at different local and/or remote locations. All or part of the data processing system may be disposed on the vessel 20, on a streamer 30, on a platform, at a remote processing facility, etc., depending on the particular embodiment of the invention.

In the example that is depicted in FIG. 8, the data processing system 400 includes a processor 404, which executes program instructions 412 that are stored in a system memory 410 for purposes of causing the processor 404 to perform some or all of the techniques that are disclosed herein. As non-limiting examples, the processor 404 may include one or more microprocessors and/or microcontrollers, depending on the particular implementation. In general, the processor 404 may execute program instructions 412 for purposes of causing the processor 404 to perform all or parts of the techniques 200, 220 and/or 250 as well as implement the 3-D sea surface generation model 290, in accordance with the various embodiments of the invention.

The memory 410 may also store datasets 414 which may be initial, intermediate and/or final datasets produced by the processing by the processor 404. For example, the datasets 414 may include data indicative of seismic data, particle motion data, data indicative of acoustic measurements emitted by pingers, data indicative of acoustic measurements indicated by acoustic sources for purposes of determining depth and/or sea surface shape, data indicative of streamer depths, data indicative of travel times of sea surface reflected, sea bottom reflected and direct arrival travel times, etc.

As depicted in FIG. 8, the processor 404 and memory 410 may be coupled together by at least one bus 408, which may couple other components of the processing system 400 together, such as a network interface card (NIC) 424. As a non-limiting example, the NIC 424 may be coupled to a network 426, for purposes of receiving such data as acoustic measurement data, seismic data, radar back scattering measurement data, streamer inclination measurement data, etc. As also depicted in FIG. 8, a display 420 of the processing system 408 may display initial, intermediate or final results produced by the processing system 400. In general, the display 420 may be coupled to the system 400 by a display driver 416. As a non-limiting example, the display 420 may display an image, which graphically depicts sea surface shape, sea surface depth, etc.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
receiving data indicative of acoustic measurements acquired by receivers disposed on a seismic receiver spread comprising at least one streamer; and
processing the data in a machine to determine a depth of the spread.

2. The method of claim 1, wherein the acoustic measurements are indicative of acoustic energy produced by acoustic sources disposed on the spread.

3. The method of claim 1, wherein the processing comprises processing the acoustic measurements to determine the depth of the spread at different points of the spread.

4. The method of claim 1, wherein the processing comprises:
determining the depth based on travel times of surface reflections indicated by the acoustic measurements and offsets between the receivers and at least one acoustic source.

5. The method of claim 1, wherein the processing comprises:
determining the depth based on travel times of surface reflections indicated by the acoustic measurements and travel times of direct arrivals indicated by the acoustic measurements.

6. A method comprising:
receiving data indicative of acoustic measurements acquired by receivers disposed on a seismic receiver spread comprising at least one streamer; and
processing the data in a machine to determine a sea surface shape.

7. The method of claim 6, wherein the acoustic measurements are indicative of acoustic energy produced by acoustic pingers disposed on the spread, the acoustic pingers also being used in the positioning of the seismic spread.

8. The method of claim 6, wherein the processing comprises processing the acoustic measurements to determine the depth of the spread at different points of the spread.

9. The method of claim 6, wherein the processing comprises:
determining the sea surface shape based on travel times of surface reflections indicated by the acoustic measurements, offsets between the receivers and at least one acoustic source and travel times of direct arrivals indicated by the acoustic measurements.

10. The method of claim 6, wherein the processing further comprises:
determining the sea surface shape based at least in part on at least one of the following: a measured depth acquired by depth sensors, back scattering data acquired by a wave radar and streamer inclination measurements.

11. A system comprising:
an interface to receive data indicative of acoustic measurements acquired by receivers disposed on a seismic receiver spread including at least one streamer; and
an interface to process the data to determine a depth of the spread.

12. The system of claim 11, wherein the acoustic measurements are indicative of acoustic energy produced by acoustic sources disposed on the spread.

13. The system of claim 11, wherein the processor is adapted to process the acoustic measurements to determine the depth of the spread at different points of the spread.

14. The system of claim 11, wherein the processor is adapted to determine the depth based on travel times of surface reflections indicated by the acoustic measurements and offsets between the receivers and at least one acoustic source.

15. The system of claim 11, wherein the processor is adapted to determine the depth based on travel times of surface reflections indicated by the acoustic measurements and travel times of direct arrivals indicated by the acoustic measurements.

16. The system of claim 11, further comprising:
a survey vessel to tow the seismic receiver spread.

17. The system of claim 11, wherein the processor is disposed in the seismic receiver spread.

18. A system comprising:
an interface to receive data indicative of acoustic measurements acquired by receivers disposed on a seismic receiver spread comprising at least one streamer; and
a processor to process the data to determine a sea surface shape.

19. The system of claim 18, wherein the processor is adapted to determine the sea surface shape based on travel times of surface reflections indicated by the acoustic measurements, offsets between the receivers and at least one acoustic source and travel times of direct arrivals indicated by the acoustic measurements.

20. The system of claim 18, wherein the processor is adapted to determine the sea surface shape based at least in part on at least one of the following: a measured depth acquired by depth sensors, back scattering data acquired by a wave radar and streamer inclination measurements.

21. The system of claim 18, further comprising:
a survey vessel to tow the seismic receiver spread.

22. The system of claim 21, wherein the processor is disposed in the seismic receiver spread.

23. An article comprising a computer readable storage medium storing instructions that when executed by a computer cause the computer to:
receive data indicative of acoustic measurements acquired by receivers disposed on a seismic receiver spread comprising at least one streamer; and
process the data to determine a depth of the spread.

24. An article comprising a computer readable storage medium storing instructions that when executed by a computer cause the computer to:
receive data indicative of acoustic measurements acquired by receivers disposed on a seismic receiver spread comprising at least one streamer; and
process the data to determine a sea surface shape.
